(19) United States
(12) Patent Application Publication
(10) Pub. No.: US 2004/0002979 A1
(43) Pub. Date: Jan. 1, 2004

(54) Global entity identification mapping

(75) Inventors: Wayne Charles Seguin, Lake Worth, FL (US); Oleg Mikulinsky, Boca Raton, FL (US)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(73) Assignee: PartnerCommunity, Inc., Boca Raton, FL

(21) Appl. No.: 10/186,380

(22) Filed: Jun. 27, 2002

(51) Int. Cl. G06F 17/30

(52) U.S. Cl. 707/10

(57) ABSTRACT

A system, method and computer readable medium for mapping file identifications is disclosed. The method on a server includes receiving a file from a first partner, wherein the file is intended for a second partner. The file includes a first partner ID. If the server finds in a database a second partner ID corresponding to the first partner ID, the server integrates the second partner ID with the file and proceeds to send the file to the second partner. If the server does not find in the database a second partner ID corresponding to the first partner ID, the server generates a global file ID for the file. Then the server integrates the global file ID with the file and proceeds to send the file to the second partner. Subsequently, the server enters a link between the first partner ID and the second partner ID in the database.

### BACKGROUND OF THE INVENTION

1. Field of the Invention

This invention generally relates to the field of identification mapping and more specifically to identification mapping between entities having separate identification paradigms.

2. Description of Related Art

As the use of the Internet has increased over recent years, so has the exchange of information and ideas. File and information sharing, in particular, has enjoyed increasing popularity over the last few years. However, the growth of the Internet has posed some interesting obstacles in the field of file and entity identification. As users and companies increasingly send and receive files between different domains, it is often difficult to keep track of file identifications, synchronizing and cross-referencing file identifications and recording identifications included within exchanged files and messages. Namely, it is difficult to keep track of an identification, or ID, when the ID leaves its native domain. Heretofore, the term “file” refers to a file, a message, a file or message component, a record or a file within a file.

FIG. 1 illustrates the difficulty in keeping track of synchronized file identifications. FIG. 1 is a Venn diagram illustrating the arrangement of domains in a universe of identification elements. FIG. 1 shows a universe 102 of ID elements. Universe 102 represents the real world universe of all files and file IDs. FIG. 1 also shows domain 104, domain 106, domain 108 and domain 110. Note that domain 106 is a subset of domain 104. The problem currently posed involves the fact that file identifications can be unique and of different types or format. A file ID can be unique within a domain, such as domain 108 or domain 110. However, when the file ID is taken out of its native domain, the file ID may cease to be unique. Further, a file ID can be of a particular type or format that is supported only in a particular domain. When the file ID is taken out of its native domain, the file ID may cease to be supported or understood. Moreover, a universally unique identifier may be used, which maintains the uniqueness of identifiers across all domains. However, this approach implies that two or more unique identifiers are associated with a single file. Therefore, a mechanism is needed to synchronize the different identifiers of a file. In addition, a mechanism is needed to help users understand that they are referring to the same file even when they are using different identifiers.

As an example, domain 108 is a retail store that uses a naming algorithm to define its file IDs, representing retail products. An example ID is TS6SHAXLS108. Domain 110 is a manufacturer that uses a different naming algorithm to define its file IDs, representing manufactured products provided to the retail store. An example ID is TS6SHAXLS110. Though the file IDs created by the retail store are unique and supported within the domain 108, the file IDs may cease to be unique or supported within domain 110 of the manufacturer. Likewise, the file IDs created by the manufacturer are unique and supported within the domain 110, but the file IDs may cease to be unique or supported within domain 108 of the retail store. This produces a problem when files are exchanged between the retail store and the manufacturer. Specifically, even when both IDs TS6SHAXLS108 and TS6SHAXLS110 are unique in the universe 102, the systems in domains 108 and 110 refer to the same file with two different IDs. Therefore, it is necessary for a domain 110 user to understand that when a domain 108 user references the ID TS6SHAXLS108, he actually means TS6SHAXLS110.

FIG. 1 further shows domain 104 and domain 106 a subset of domain 104. Domains 104 and 106 show that file IDs can further be organized within a domain. As an example, domain 104 is a manufacturer having file IDs for manufactured products. FIG. 1 shows that domain 106 is a sub-domain of domain 104. Domain 106 contains, for example, invoice files relating to the sale of manufactured products. The manufacturer uses a naming algorithm to define file IDs in domain 106 and a different naming algorithm to define file IDs in the remaining part of domain 104. Though the file IDs for products created by the manufacturer are unique and supported within the domain 104, the file IDs may cease to be unique or supported within sub-domain 106 of the manufacturer. Likewise, the file IDs created by the manufacturer for invoices are unique and supported within the domain 106, but the file IDs may cease to be unique or supported within domain 104 of the manufacturer. This produces a problem when product files are mixed with invoice files of the manufacturer. In essence, we are still faced with two sub-domains that are referring to the same file with two separate identifiers.

Another problem with the sharing of files, according to FIG. 1, arises when a file includes references to other files. For example, domain 108 can exchange with domain 110 a file, say file A, that contains references, or file IDs, to other files. In this scenario, the file ID within file A within domain 108 is unique only within file A's context. In this example, the problem arises when the file ID in file A in domain 108 is moved to a separate file in a separate domain, such as domain 110 or out of domain 108 and into the universe 102. This produces a problem when files containing file IDs are moved out of their native domain.

Therefore a need exists to overcome the problems with the prior art as discussed above, and particularly for a way to manage, synchronize and cross-reference unique file identifications over different domains.

### SUMMARY OF THE INVENTION

Briefly, in accordance with the present invention, disclosed is a system, method and computer readable medium for mapping file identifications, message identifications, identifications of a file or message component, identifications of a record within a file or message, or entity identifications. In an embodiment of the present invention, the method on a server information processing system (i.e., the server) includes receiving a file from a first partner or first client information processing system, wherein the file is intended for a second partner or second client information processing system. The file includes a file identification associated with the first partner, i.e., a first partner ID. Subsequently, the server accesses a database for linking first partner IDs with second partner IDs. If the server finds in the database a second partner ID corresponding to the first partner ID, the server integrates the second partner ID with the file and proceeds to send the file to the second partner. If the server does not find in the database a second partner ID corresponding to the first partner ID, the server generates a global file identification (i.e., a global file ID) for the file. Then, the server integrates the global file ID with the file and proceeds to send the file to the second partner. Subsequently, the server receives from the second partner a second partner ID associated with the file. Lastly, the server enters a link between the first partner ID and the second partner ID in the database for linking first partner IDs with second partner IDs.

This embodiment of the present invention is advantageous as it allows for the quick and easy exchange of files over domains having different naming conventions. This increases the compatibility and efficiency of file systems.

In another embodiment of the present invention, the methods performed by the server system in the embodiment above are performed by a module located on each partner's systems. In this embodiment, the method on a first partner client information processing system includes preparing a file for sending to a second partner or second client information processing system. The file includes a first partner ID. Subsequently, the module on the first partner's system accesses a database for linking first partner IDs with second partner IDs. If the module finds in the database a second partner ID corresponding to the first partner ID, the module integrates the second partner ID with the file and proceeds to send the file to the second partner. If the module does not find in the database a second partner ID corresponding to the first partner ID, the module generates a global file ID for the file. Then the module integrates the global file ID with the file and proceeds to sending the file to the second partner. Subsequently, the module receives from the second partner's system a second partner ID associated with the file. Lastly, the module enters a link between the first partner ID and the second partner ID in the database for linking first partner IDs with second partner IDs.

This embodiment of the present invention is advantageous as it allows for the quick and easy exchange of files over domains in a point-to-point environment, without requiring the use of an intermediary hub server. This increases the compatibility and efficiency of communicating business support systems. In addition, this decreases resource consumption as a dedicated hub server is not required.

The foregoing and other features and advantages of the present invention will be apparent from the following more particular description of the preferred embodiments of the invention, as illustrated in the accompanying drawings.

### BRIEF DESCRIPTION OF THE DRAWINGS

FIG. 1 is a Venn diagram illustrating the arrangement of domains in a universe of identification elements.

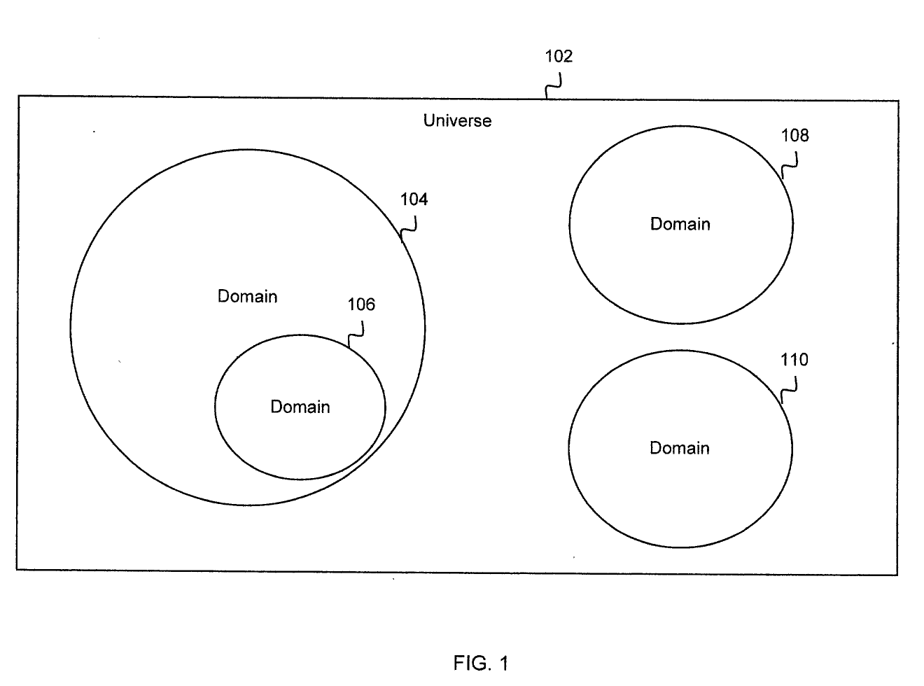

FIG. 2A is a block diagram illustrating a first view of the overall system architecture of the hub-and-spoke embodiment of the present invention.

FIG. 2B is a block diagram illustrating a second view of the overall system architecture of the hub-and-spoke embodiment of the present invention.

FIG. 2C is a block diagram illustrating the overall system architecture of the peer-to-peer embodiment of the present invention.

FIG. 3A is a functional diagram illustrating the static mapping process of the hub-and-spoke embodiment of the present invention.

FIG. 3B is a functional diagram illustrating the dynamic mapping process of the hub-and-spoke embodiment of the present invention.

FIG. 4 is a flowchart depicting the operation and control flow of the overall process of the hub-and-spoke embodiment of the present invention.

FIG. 5A is a functional diagram illustrating the static mapping process of the peer-to-peer embodiment of the present invention.

FIG. 5B is a functional diagram illustrating the dynamic mapping process of the peer-to-peer embodiment of the present invention.

FIG. 6 is a flowchart depicting the operation and control flow of the overall process of the peer-to-peer embodiment of the present invention.

FIG. 7 is a block diagram of a computer system useful for implementing the present invention.

### DESCRIPTION OF THE PREFERRED EMBODIMENTS

Terminology

To more clearly point out and describe the present invention, an effort is made throughout the specification to adhere to the following term definitions as consistently as possible.

The term “file” refers to a file, a file component, a record or a file within a file.

The term “domain” refers to a subset of elements in a universe of elements. Elements are typically files and a domain corresponds to an abstracted area in which the files may be located, such as a hard disk, a computer or a network.

The terms “ID” or “identifier” refer to an identification, typically of a file. An ID or identifier is typically a number or an alphanumeric string used to uniquely identify a file in a domain.

The terms “public ID” or “community ID” refer to an ID that is universally, or globally, unique.

The term “private ID” refers to an ID that is unique only within a particular domain.

The term “simple ID” refers to an ID that can uniquely identify a file with a single data element, such as a number.

The term “compound ID” refers to an ID that uniquely identifies a file using multiple data elements, such as a series of numbers.

The term “partner” refers to an entity or individual that is a party to the exchange of files. A partner is typically an organization having a server information processing system for sending and receiving files comprising an ID. It is important to note that two or more partners may be members of a same organization or company or each partner may belong to a separate organization or company. An example of a partner is a retail store.

The term “partner ID” is a private ID that is unique only in the domain of a partner.

The term “XML” refers to Extended Markup Language, which is a simple dialect of Standard Generalized Markup Language (SGML) suitable for use on the World-Wide Web. SGML is a generic markup language for representing documents.

The term “XPath” refers to a language that describes a way to locate and process items in XML documents by using an addressing syntax based on a path through the document's logical structure or hierarchy.

Overview

The present invention, according to a preferred embodiment, overcomes problems with the prior art by mapping file identifications. The exemplary embodiments of the present invention provide a system wherein file identifications are mapped during transit of files between partners.

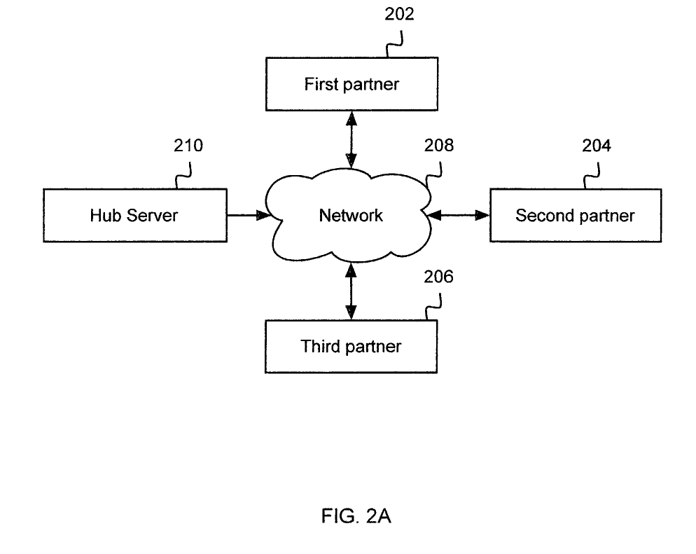

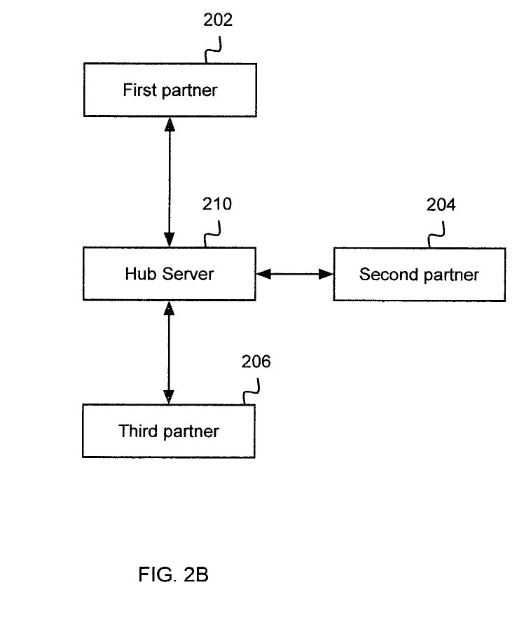

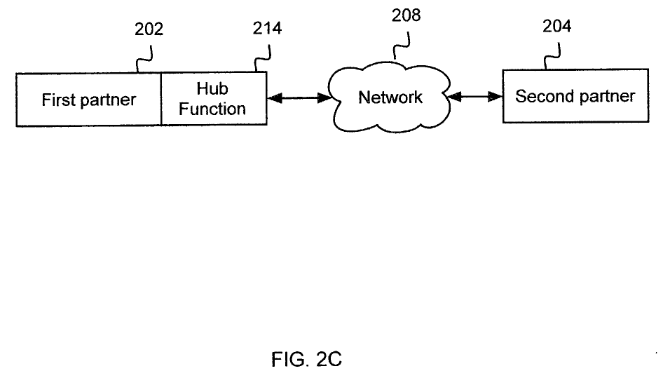

FIG. 2A is a block diagram illustrating a first view of the overall system architecture of the hub-and-spoke embodiment of the present invention. FIG. 2A shows a first partner 202, a second partner 204, a third partner 206 and a hub server 210. It should be noted that the system of the present invention supports any number of partners. FIG. 2A also shows a network 208, described in greater detail below. In the hub-and-spoke embodiment, multiple partners (partners 202-206) connect to the hub server 210 for execution of the mapping process. In this embodiment, a first partner 202 sends a file to the hub server 210 via network 208, wherein the file is ultimately intended for the second partner 204. The hub server 210 maps the identification associated with the file and sends the file with a new identification to the second partner 204. FIG. 2A indicates that partner 202, partner 204 and partner 206 may communicate with each other directly (i.e. not through the hub server 210). However, communications in this embodiment of the present invention occur through the hub server 210. This process is described in greater detail below.

In an embodiment of the present invention, the computer systems of first partner 202, second partner 204, third partner 206 and hub server 210 comprise a desktop computer, a laptop computer, a Personal Digital Assistant (PDA), a palmtop computer, a game console or any other computer processing device. The computer systems of first partner 202, second partner 204, third partner 206 and hub server 210 comprise the IBM platform, the Apple platform, the SGI platform, the Sun platform or any another available computer platform. In addition, the computer systems of first partner 202, second partner 204, third partner 206 and hub server 210 execute the Microsoft Windows 95198/2000/ME/CE/NT/XP operating system, the Mac OS operating system, the UNIX operating system, the LINUX operating system, the AIX operating system or any other available operating system. The computer systems of first partner 202, second partner 204, third partner 206 and hub server 210 are described in greater detail below.

FIG. 2A shows network 208 for connecting the computer systems of first partner 202, second partner 204 and third partner 206 to hub server 210. In one embodiment of the present invention, network 208 is a circuit switched network, such as the Public Service Telephone Network (PSTN). In another embodiment of the present invention, the network 208 is a packet switched network. The packet switched network is a wide area network (WAN), such as the global Internet, a private WAN, a local area network (LAN), a telecommunications network or any combination of the above-mentioned networks. In another embodiment of the present invention, network 208 is a wired network, a wireless network, a broadcast network or a point-to-point network.

FIG. 2B is a block diagram illustrating a second view of the overall system architecture of the hub-and-spoke embodiment of the present invention. FIG. 2B focuses on the hub-and-spoke aspect of the overall system architecture of the present invention. FIG. 2B shows that each partner, first partner 202, second partner 204 and third partner 206, connect directly to the hub server 210. Therefore, all traffic between the partners 202-206 must pass through hub server 210. N number of partners can be connected in this configuration. This arrangement allows the hub server 210 to execute the mapping process of the present invention. Note that network 208 is implicit in FIG. 2B though not shown. In FIG. 2B, network 208 exists between each partner 202-206 and the hub server 210.

FIG. 2C is a block diagram illustrating the overall system architecture of the peer-to-peer embodiment of the present invention. In this alternative embodiment, the hub server functions of hub server 210 are performed by a hub function module 214 on each partner 202-206. That is, in this embodiment shown in FIG. 2C, the functions and operations performed by the hub server 210 of FIG. 2B are performed by a hub function module 214 located on each partner's network. FIG. 2C shows first partner 202 including a hub function module 214, second partner 204 and network 208. In this embodiment, first partner 202 prepares to send a file to second partner 204. Before sending the file to the second partner 204, the hub function module 214 maps the identification of the file to a new file identification. The first partner 202 then sends the file including the new file identification to the second partner 204. This process is described in greater detail below.

Hub and Spoke Embodiment.

The present invention relates to technology described in a non-provisional patent application Ser. No. 10/102,587, filed Mar. 20, 2002 now [Pending], for “Creating, Distributing, And Enforcing Relational And Business Rules At Front-End Applications” which is a continuation in part of Ser. No. 09/840,655, filed Apr. 23, 2001 now [Pending], for “Method And System For Managing Multiple Interpretations For A Single Agreement In A Multilateral Environment”, which is a continuation-in-part of a non-provisional patent application Ser. No. 09/757,227 filed Jan. 9, 2001 now [Pending], for “Method And System For Managing And Correlating Orders In A Multilateral Environment”, both of which is commonly assigned herewith to PartnerCommunity, Inc. and each which are hereinto incorporated by reference in their entirety.

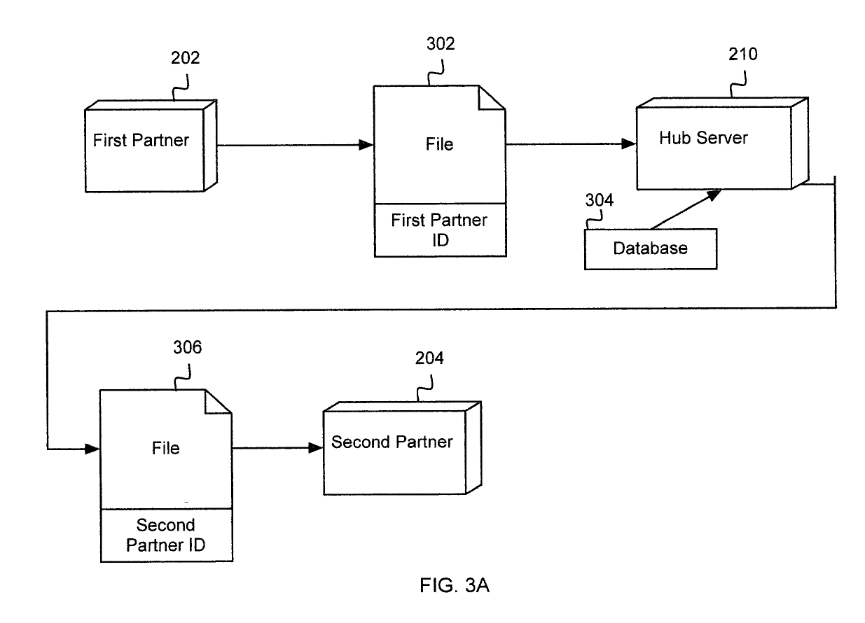

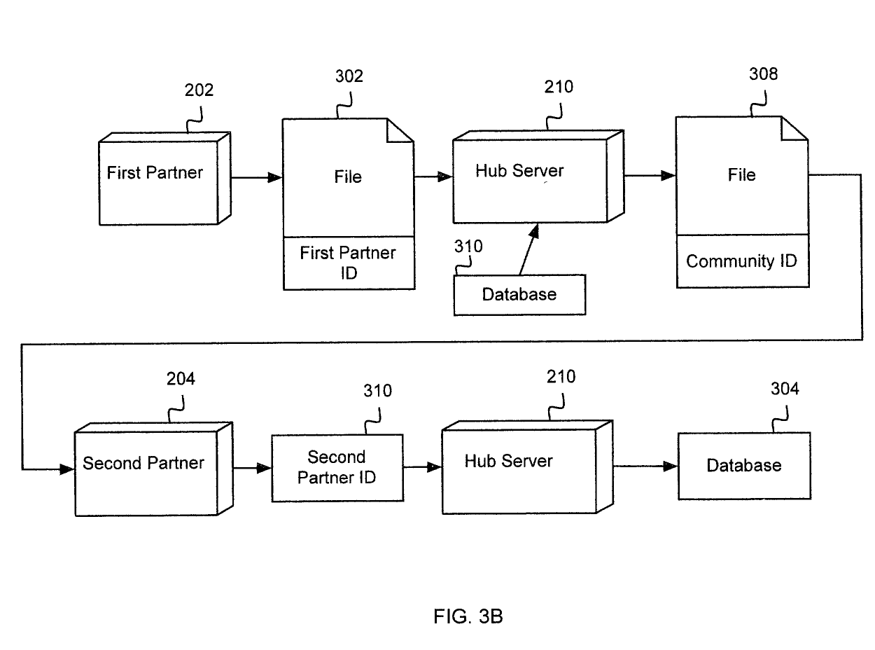

FIG. 3A is a functional diagram illustrating the static mapping process of the hub-and-spoke embodiment of the present invention. The process of FIG. 3A begins with first partner 202 sending a file 302 including a first partner ID to the hub server 210. The file 302 is intended for second partner 204, but is first routed to the hub server 210 due to the hub-and-spoke paradigm of this embodiment of the present invention. The first partner ID is a file identification of file 302 associated with the first partner 202. That is, the first partner ID is a private ID that is unique and supported only in a domain of the first partner 202. Because the first partner ID of file 302 is not globally unique or globally supported, it is necessary for the first partner ID to be mapped to an identification that is understood by second partner 204. Next, the hub server 210 receives the file 302 and proceeds to read the first partner ID.

In an embodiment of the present invention, the hub server 210 utilizes a set of records to determine the location of the first partner ID in the file 302. Below are sets of exemplary records that may be used by the hub server 210 in accomplishing this task.

| IDMapDef | IDMapElement |
|---|---|
| PartnerID | MapID |
| DocType | Seq |
| Position | ImpliedOrder |
| MapID | XPath |
| IDGroup | |

The first record, the IDMapDef record, holds information pertaining to a particular document type for a particular partner. For each type of document that is supported by the hub server 210, the hub server 210 stores an IDMapDef record. The IDMapDef record shown above includes a PartnerID attribute, a DocType attribute, a Position attribute, a MapID attribute and an IDGroup attribute. The PartnerID attribute is a value that uniquely identifies the partner from which file 302 was received. The PartnerID attribute is stored as a set of alphanumeric characters or a number. The DocType attribute is a value that uniquely identifies the type of document contained in file 302. The DocType attribute can indicate various levels of document type, such as general file type and document format. For example, the DocType attribute can indicate that file 302 is a word processing file and that file 302 is a Microsoft Word document. The DocType attribute can also indicate more detailed information about file 302, such as information indicating document structure. The DocType attribute is stored as a set of alphanumeric characters or a number.

The Position attribute indicates the position of the pertinent ID in the file 302. A file 302 can include any number of file identifications. The Position attribute indicates the position of the pertinent ID, among the various file identifications, in file 302. The Position attribute is stored as a number. The IDGroup attribute indicates a group to which the pertinent ID of file 302 pertains. As explained above, a file 302 can comprise any number of file identifications. IDGroups organize sets of file identifications into one group. That is, all file identifications belonging to the same IDGroup are compatible and correspond to the same partner. The IDGroup attribute is stored as a number.

The MapID attribute is a unique number that indicates a particular mapping set or IDMapElement record. For each IDMapDef record, there is at least one corresponding IDMapElement record. In the case of a single IDMapElement record, this record indicates in detail the location of the first partner ID in a particular file 302. In the case of multiple IDMapElement records, each record, based on the sequence, indicates a part of the first partner ID in a particular file 302. The separation of the IDMapDef record and the IDMapElement record allows re-use of IDMapElement records as there can be a many-to-one correspondence between IDMapDef records and IDMapElement records.

The second record, the IDMapElement record, includes a MapID attribute, a Seq attribute, an ImpliedOrder attribute and a XPath attribute. For each IDMapDef record, the hub server 210 stores a corresponding IDMapElement record. In the IDMapElement record, the MapID attribute is a unique number that, together with the Seq, identifies the set of IDMapElement records. The MapID attribute of the IDMapElement record corresponds to the MapID attribute of the IDMapDef record. The importance of the Seq attribute is to allow file IDs to be constructed from multiple parts distributed through out a file. When the Seq attribute is set to 0 this indicates that the partner ID is a simple ID that is constructed from only one XPath element. For complex partner IDs, all parts of a partner ID will have the same MapID and incremented Seq attribute.

The ImpliedOrder attribute indicates the order in which the repeatable XPath elements shall be evaluated. If the ImpliedOrder attribute is set to an affirmative state, the XPath elements are evaluated one at a time in the order in which they are stored. Otherwise, the ImpliedOrder attribute refers to an attribute of the XPath element that contains the order of the Xpath elements. The ImpliedOrder attribute is stored as one bit. The Seq attribute indicates the sequential order in which the partner ID is constructed from evaluating XPath elements. Notice that the Seq attribute refers to multiple XPath elements whereas the ImpliedOrder attribute refers to the same XPath element that is repeatable. The XPath attribute indicates an XPath to the location of part of or the complete pertinent ID of file 302. The XPath attribute is stored as text or a string of characters.

Returning to FIG. 3A, the hub server 210 receives file 302 and proceeds to read the first partner ID of file 302. In an embodiment, the hub server 210 accesses a database 304 comprising IDMapDef records corresponding to the file 302. The hub server 210 accomplishes this task, for example, by searching for the IDMapDef record having the PartnerID and DocType corresponding to the file 302. This can be accomplished using Structured Query Language (SQL) or any other database access method used on a database comprising records. Subsequently, the IDMapElement record corresponding to the appropriate IDMapDef record is retrieved. The hub server 210 accomplishes this task by accessing the IDMapElement record having the same MapID attribute as the MapID attribute located in the appropriate IDMapElement record. Utilizing the Seq and ImpliedOrder attributes as explained above, the XPath attribute is then read from the IDMapElement record. The XPath attribute provides the location, as explained above, of the first partner ID of file 302. Using the XPath information, the hub server 210 proceeds to read the first partner ID of file 302.

Next, the hub server 210 accesses a database 304 comprising a set of records linking first partner IDs and second partner IDs. In one embodiment the database 304 includes a set of records, wherein each record includes a first partner ID and a corresponding second partner ID. Thus, for each partner ID, the corresponding ID of the other partner is defined. Consequently, the hub server 210 searches for the first partner ID in the database 304. When the appropriate record is found, the hub server 210 reads the corresponding second partner ID from the record. Then, the hub server 210 associates or integrates the read second partner ID with the file 302. This new file, file 306, is identical to the file 302, except for the file identification associated with it. File 306 is then sent to second partner 204. In another embodiment, the database 304 includes a set of records, wherein each record includes a partner ID and a community ID. A single community ID establishes the correspondence between multiple partner IDs.

FIG. 3B is a functional diagram illustrating the dynamic mapping process of the hub-and-spoke embodiment of the present invention. The process of FIG. 3B begins with first partner 202 sending a file 302 including a first partner ID to the hub server 210. The file 302 is intended for second partner 204, but is first routed to the hub server 210 due to the hub-and-spoke paradigm of this embodiment of the present invention. Next, the hub server 210 receives the file 302 and proceeds to read the first partner ID.

In an embodiment of the present invention, the hub server 210, utilizing the same method used in the static mapping process, accesses the IDMapDef record corresponding to the file 302. Subsequently, the IDMapElement record corresponding to the appropriate IDMapDef record is retrieved. The XPath attribute is then read from the IDMapElement record. The XPath attribute provides the location of the first partner ID of file 302. Using the XPath information, the hub server 210 proceeds to read the first partner ID of file 302.

Next, the hub server 210 accesses a database 310 comprising a set of records linking first partner IDs and community IDs. The database 310 includes a set of records, wherein each record includes a first partner ID and a corresponding community ID. Thus, for each partner ID, the corresponding community ID is defined. Below is an example of a record in database 310.

MappedID
IDGroup
PrivateID
CommunityID

The MappedID record of database 310 above shows an IDGroup attribute, a PrivateID attribute and a CommunityID attribute. The IDGroup attribute is described above in greater detail. The PrivateID attribute represents the first partner ID of file 302. This attribute is used to store the partner ID provided in the file that is received by hub server 210 in this embodiment. The PrivateID attribute is stored as a string of text or alphanumeric characters. The CommunityID attribute represents the globally unique ID, or community ID, of file 302. This attribute is used to store the globally unique ID corresponding to the partner ID of the file that is received by hub server 210 in this embodiment. The CommunityID attribute is stored as a string of text or alphanumeric characters.

Returning to FIG. 3B, the hub server 210 searches for the first partner ID in the database 310. When the appropriate record is found, the hub server 210 reads the corresponding community ID. Then, the hub server 210 associates or integrates the read community ID with the file 302. This new file, file 308, is identical to the file 302, except for the file identification associated with it. File 308 is then sent to second partner 204. In the case where the hub server does not find in database 310 a corresponding community ID for the first partner ID, the hub server 210 creates a community ID for the file 302. The hub server 210 accomplishes this task by creating a globally unique number or value and using this number of value to produce a file identification for file 302.

Next, the second partner 204 receives the file 308 and proceeds to produce a second partner ID 310 for the file 308. The generated second partner ID 310 is then sent to hub server 210, wherein the second partner ID 310 is associated with the community ID received in file 308.

Next, the hub server 210 accesses a database 304 comprising a set of records linking first partner IDs and second partner IDs. The database 304 includes a set of records, wherein each record includes a first partner ID and a corresponding second partner ID. Consequently, the hub server 210 searches for the first partner ID of file 302 in the database 304. When the appropriate record is found, the hub server 210 enters the second partner ID 310 into the record. This completes the correspondence between the first partner ID of file 302 and the second partner ID 310 in database 304. Thus, in the future, when the file 302 is sent from the first partner 202 to the second partner 204, the hub server 210 will find the correspondence between the first partner ID of file 302 and the second partner ID 310 in database 304, and the hub server can circumvent the process of FIG. 3B by executing the process of FIG. 3A.

In an embodiment of the present invention, in the process of FIG. 3A and the process of FIG. 3B, the hub server 210 performs a determination upon receipt of the file 302. This determination includes determining whether an entry exists in the database 304 for the first partner ID of file 302. If an entry exists in the database 304 for the first partner ID of file 302, then the remaining steps of the process of FIG. 3A are executed. If an entry does not exist in the database 304 for the first partner ID of file 302, then the remaining steps of the process of FIG. 3B are executed. This allows for the static mapping process of FIG. 3A and the dynamic mapping process of FIG. 3B to execute in complement to each other. This is described in greater detail below.

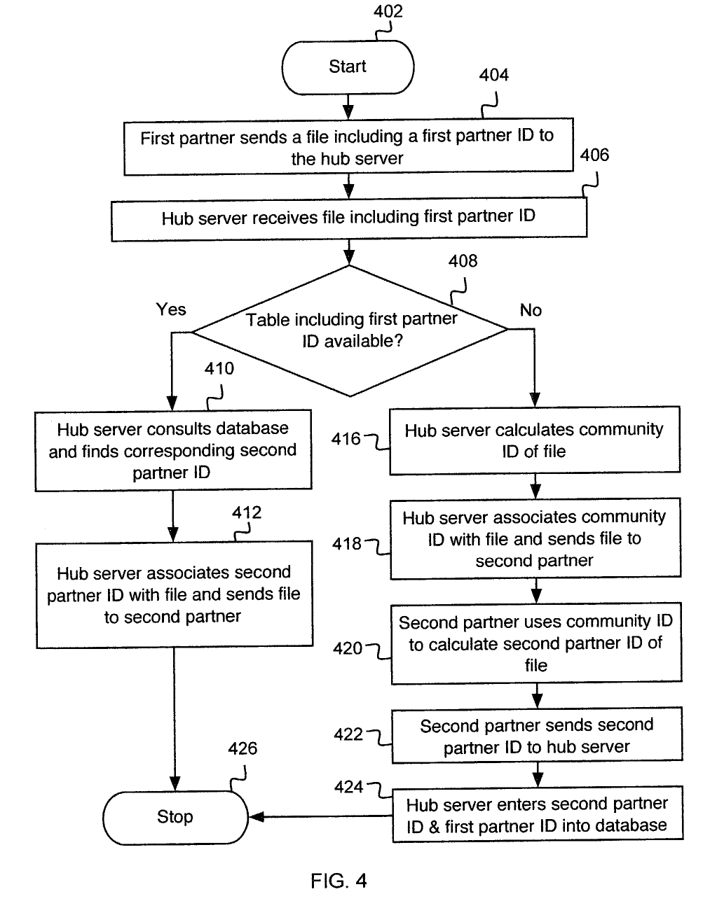

FIG. 4 is a flowchart depicting the operation and control flow of the overall process of the hub-and-spoke embodiment of the present invention. The control flow of FIG. 4 begins with step 402 and flows directly to step 404. In step 404, the first partner 202 sends a file 302 including a first partner ID to hub server 210, wherein the file 302 is ultimately intended for second partner 204. In step 406, the hub server 210 receives the file 302 and proceeds to read the first partner ID from the file 302. This process is described in greater detail above.

In step 408, the hub server 210 determines whether an entry for the first partner ID of file 302 exists in the database 304. If an entry for the first partner ID of file 302 exists in the database 304, control flows to step 410. If an entry for the first partner ID of file 302 does not exist in the database 304, control flows to step 416. In step 410, the hub server 210 reads the second partner ID corresponding to the first partner ID in the database 304. Note that the second partner ID may have been created as part of an earlier communication between partner 202 and partner 204 where control followed step 416 or through a pre-configured association of the first partner IDs and the second partner IDs. In step 412, the hub server 210 associates or integrates the second partner ID with the file 302, now file 306, and proceeds to send the file 306 to the second partner 204.

In step 416, the hub server 210 produces a community ID for the file 302. The hub server accomplishes this task by either finding a community ID corresponding to the first partner ID of file 302 in database 310 or by generating a globally unique community ID. In step 418, the hub server 210 associates the community ID of step 416 with the file 302, now file 308, and sends file 308 to the second partner 204.

In step 420, the second partner 204 receives the file 308 and proceeds to generate a second partner ID 310 for the file 308, wherein the second partner ID 310 corresponds to the first partner ID of file 302. In step 422, the generated second partner ID 310 is sent to hub server 210. In step 424, the hub server 210 enters the second partner ID 310 into the database 304, indicating a correspondence between the first partner ID of file 302 and the second partner ID 310. In step 426, the control flow of FIG. 4 ceases.

Peer-to-Peer Embodiment

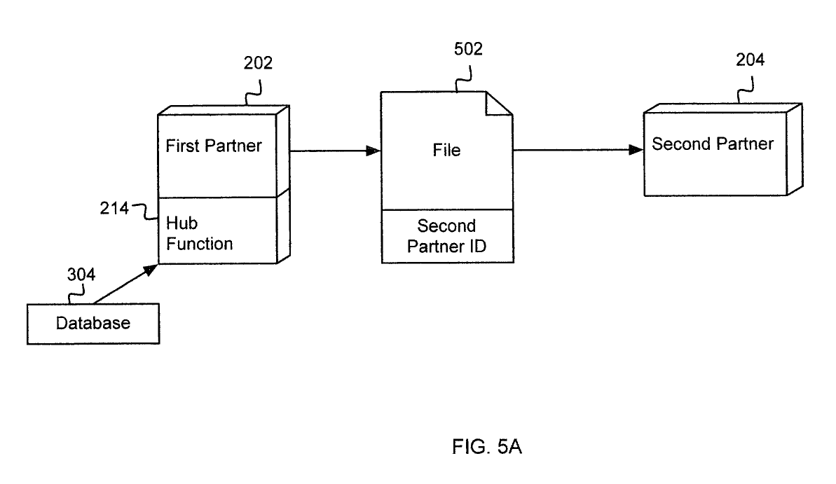

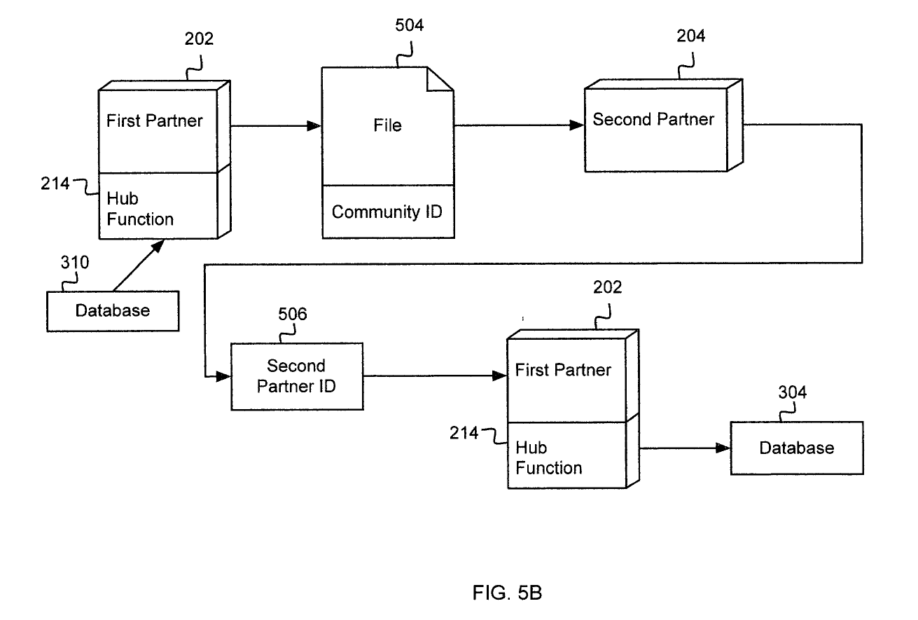

FIG. 5A is a functional diagram illustrating the static mapping process of the peer-to-peer embodiment of the present invention. The process of FIG. 5A corresponds to the static mapping process of the hub and spoke embodiment of FIG. 3A. The process of FIG. 5A begins with first partner 202, in conjunction with the hub function module 214, preparing to send a file to the second partner 204. First, hub function module 214 of the first partner 202 proceeds to read the first partner ID. In an embodiment, the hub function module 214 of the first partner 202 accomplishes this task by accessing a database 304 comprising an IDMapDef record corresponding to the file for sending. Subsequently, the IDMapElement record corresponding to the appropriate IDMapDef record is retrieved. Utilizing the Seq and ImpliedOrder attributes as explained above, the XPath attribute is then read from the IDMapElement record. The XPath attribute provides the location, as explained above, of part or the complete first partner ID of the file for sending. Using the XPath information, the hub function module 214 of the first partner 202 proceeds to read the first partner ID of the file.

Next, hub function module 214 of the first partner 202 accesses a database 304 comprising a set of records linking first partner IDs and second partner IDs. In one embodiment the database 304 includes a set of records, wherein each record includes a first partner ID and a corresponding second partner ID. Consequently, the hub function module 214 of the first partner 202 searches for the first partner ID in the database 304. When the appropriate record is found, the hub function module 214 of the first partner 202 reads the corresponding second partner ID from the record. Then, the hub function module 214 of the first partner 202 associates or integrates the read second partner ID with the file for sending. This new file, file 502, is then sent to second partner 204.

In another embodiment the database 304 includes a set of records, wherein each record includes a partner ID and a community ID. A single unique community ID establishes the correspondence between multiple partner IDs.

FIG. 5B is a functional diagram illustrating the dynamic mapping process of the peer-to-peer embodiment of the present invention. The process of FIG. 5B corresponds to the dynamic mapping process of the hub and spoke embodiment of FIG. 3B. The process of FIG. 5B begins with first partner 202, in conjunction with hub function module 214, sending a file to second partner 204. First, the hub function module 214 of the first partner 202 prepares to read the first partner ID of the file for sending.

In an embodiment of the present invention, the hub function module 214 of the first partner 202, utilizing the same method used in the static mapping process, accesses the IDMapDef record corresponding to the file for sending. Subsequently, the IDMapElement record corresponding to the appropriate IDMapDef record is retrieved. The XPath attribute is then read from the IDMapElement record. The XPath attribute provides the location of the first partner ID of the file. Using the XPath information, the hub function module 214 of the first partner 202 proceeds to read the first partner ID of the file.

Next, the hub function module 214 of the first partner 202 accesses a database 310 comprising a set of records linking first partner IDs and community IDs. The database 310 includes a set of records, wherein each record includes a first partner ID and a corresponding community ID. Then, the hub function module 214 of the first partner 202 searches for the first partner ID in the database 310. When the appropriate record is found, the hub function module 214 of the first partner 202 reads the corresponding community ID. Then, the hub function module 214 of the first partner 202 associates or integrates the read community ID with the file. This new file, file 504, is then sent to second partner 204. In the case where the hub function module 214 of the first partner 202 does not find in database 310 a corresponding community ID for the first partner ID, the hub function module 214 of the first partner 202 creates a community ID for the file 504. The manner in which a community ID can be created is described in greater detail above.

Next, the second partner 204 receives the file 504 and proceeds to produce a second partner ID 506 for the file 504. The manner in which a second partner ID can be created is described in greater detail above. The generated second partner ID 506 is then sent to the first partner 202.

Subsequently, the hub function module 214 of the first partner 202 accesses a database 304 comprising a set of records linking first partner IDs and second partner IDs. The hub function module 214 of the first partner 202 searches for the first partner ID associated with the file 504 in the database 304. When the appropriate record is found, the hub function module 214 of the first partner 202 enters the second partner ID 506 into the record. This completes the correspondence between the first partner ID associated with the file 504 and the second partner ID 506 in database 304. Thus, the in the future, when the file 504 is sent from the first partner 202 to the second partner 204, the hub function module 214 of the first partner 202 will find the correspondence between the first partner ID associated with file 504 and the second partner ID 506 in database 304, and the process of FIG. 5B can be circumvented by executing the process of FIG. 5A.

In an embodiment of the present invention, in the process of FIG. 5A and the process of FIG. 5B, the hub function module 214 of the first partner 202 performs a determination before sending a file to second partner 204. This determination includes determining whether an entry exists in the database 304 for the first partner ID of the file for sending. If an entry exists in the database 304 for the first partner ID of the file, then the remaining steps of the process of FIG. 5A are executed. If an entry does not exist in the database 304 for the first partner ID of the file, then the remaining steps of the process of FIG. 5B are executed. This allows for the static mapping process of FIG. 5A and the dynamic mapping process of FIG. 5B to execute in complement to each other. This is described in greater detail below.

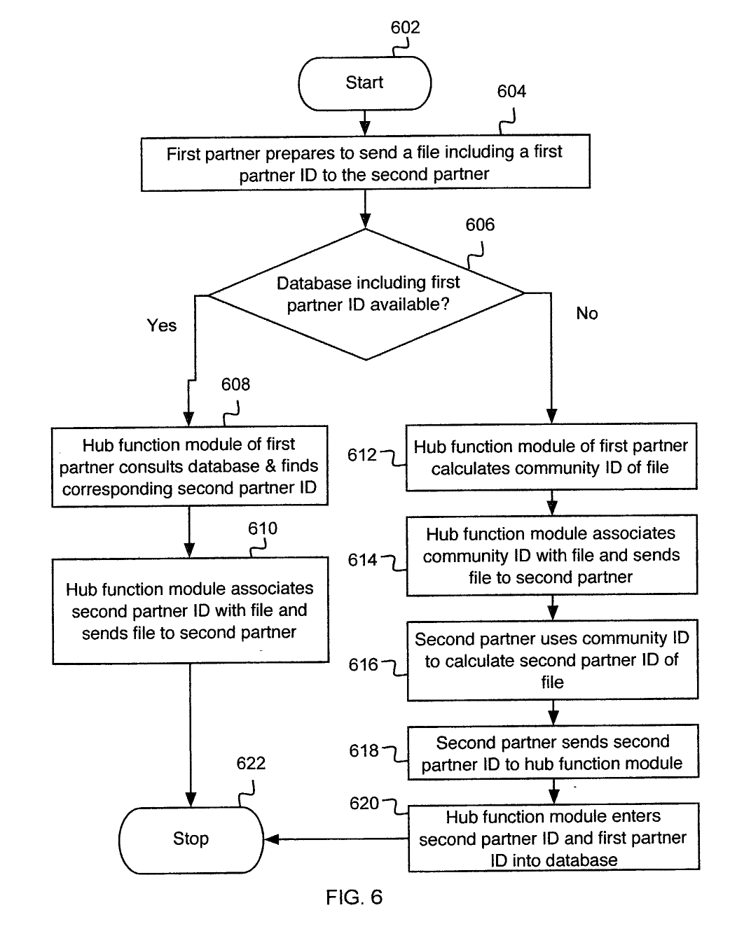

FIG. 6 is a flowchart depicting the operation and control flow of the overall process of the peer-to-peer embodiment of the present invention. FIG. 6 corresponds to the FIG. 4 of the hub and spoke embodiment. The control flow of FIG. 6 begins with step 602 and flows directly to step 604. In step 604, the first partner 202 prepares to send a file including a first partner ID to the second partner 204. In step 604, the hub function module 214 of the first partner 202 proceeds to read the first partner ID from the file for sending. This process is described in greater detail above.

In step 606, the hub function module 214 of the first partner 202 determines whether an entry for the first partner ID of the file for sending exists in the database 304. If an entry for the first partner ID of the file exists in the database 304, control flows to step 608. If an entry for the first partner ID of the file does not exist in the database 304, control flows to step 612. In step 608, the hub function module 214 of the first partner 202 reads the second partner ID corresponding to the first partner ID in the database 304. Note that the second partner ID may have been created as part of an earlier communication between partner 202 and partner 204 where control followed step 612 or through a pre-configured association of the first partner IDs and the second partner IDs. In step 610, the hub function module 214 of the first partner 202 associates or integrates the second partner ID with the file 502 and proceeds to send the file 502 to the second partner 204.

In step 612, the hub function module 214 of the first partner 202 produces a community ID for the file 504. In step 614, the hub function module 214 of the first partner 202 associates the community ID of step 612 with the file 504, and sends file 504 to the second partner 204.

In step 616, the second partner 204 receives the file 504 and proceeds to generate a second partner ID 506 for the file 504, wherein the second partner ID 506 corresponds to the first partner ID associated with file 504. In step 618, the generated second partner ID 506 is sent to the first partner 202. In step 620, the hub function module 214 of the first partner 202 enters the second partner ID 506 into the database 304, indicating a correspondence between the first partner ID associated with file 504 and the second partner ID 506. In step 622, the control flow of FIG. 6 ceases.

Exemplary Implementations

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

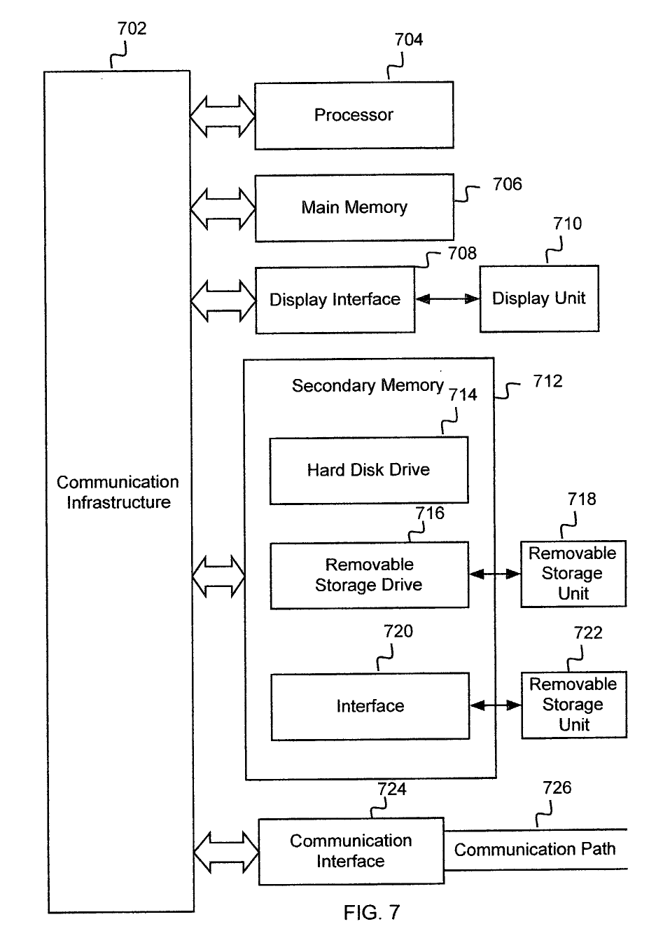

FIG. 7 is a block diagram depicting the hardware hierarchy of a computer system useful for implementing an embodiment of the present invention. The computer system includes one or more processors, such as processor 704. The processor 704 is connected to a communication infrastructure 702 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 708 that forwards graphics, text, and other data from the communication infrastructure 702 (or from a frame buffer not shown) for display on the display unit 710. The computer system also includes a main memory 706, preferably random access memory (RAM), and may also include a secondary memory 712. The secondary memory 712 may include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a manner well known to those having ordinary skill in the art. Removable storage unit 718, represents a floppy disk, magnetic tape, optical disk, etc. which is read by and written to by removable storage drive 716. As will be appreciated, the removable storage unit 718 includes a computer usable storage medium having stored therein computer software and/or data.

In alternative embodiments, the secondary memory 712 may include other similar means for allowing computer programs or other instructions to be loaded into the computer system. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computer system.

The computer system may also include a communications interface 724. Communications interface 724 allows software and data to be transferred between the computer system and external devices. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. These signals are provided to communications interface 724 via a communications path (i.e., channel) 726. This channel 726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 706 and secondary memory 712, removable storage drive 716, a hard disk installed in hard disk drive 714, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 706 and/or secondary memory 712. Computer programs may also be received via communications interface 724. Such computer programs, when executed, enable the computer system to perform the features of the present invention as discussed herein. In particular, the computer programs, when executed, enable the processor 704 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method for mapping identifications, comprising:
receiving a file from a first partner, wherein the file includes a file identification associated with the first partner;
accessing a database for linking file identifications associated with the first partner and file identifications associated with a second partner;
determining, based on the database, a file identification associated with the second partner that corresponds to the file identification associated with the first partner;
integrating the file identification associated with the second partner with the file; and
sending the file to the second partner.

2. The method of claim 1, further comprising a step before the accessing step of:
reading in the file the file identification associated with the first partner using a record defining the location in the file of the file identification associated with the first partner.

3. The method of claim 2, wherein the record defining the location in the file of the file identification associated with the first partner comprises a path defining the location in the file of the file identification associated with the first partner.

4. The method of claim 2, wherein the reading step comprises:
reading in the file the file identification associated with the first partner using multiple records defining multiple locations in the file wherein each location constitutes a portion of the file identification.

5. A method for mapping identifications, comprising:
receiving a file from a first partner, wherein the file includes a file identification associated with the first partner;
generating a global file identification for the file;
integrating the global file identification with the file;
sending the file to the second partner;
receiving from the second partner a file identification associated with the second partner, wherein the file identification corresponds to the file;
accessing a database for linking file identifications associated with the first partner and file identifications associated with a second partner; and
entering into the database a link between the file identification associated with the first partner and the file identification associated with the second partner.

6. The method of claim 5, further comprising a step before the accessing step of:
reading in the file the file identification associated with the first partner using a record defining the location in the file of the file identification associated with the first partner.

7. The method of claim 6, wherein the reading step comprises:
reading in the file the file identification associated with the first partner using multiple records defining multiple locations in the file wherein each location constitutes a portion of the file identification.

8. The method of claim 6, wherein the record defining the location in the file of the file identification associated with the first partner comprises a path defining the location in the file of the file identification associated with the first partner.

9. The method of claim 6, wherein the generating step comprises:
generating a global file identification including a unique value.

10. A method for mapping identifications, comprising:
receiving a file from a first partner, wherein the file includes a file identification associated with the first partner;
generating a global file identification for the file;
integrating the global file identification with the file;
sending the file to the second partner;
entering into the database a link between the file identification associated with the first partner and the global file identification; and
using the global file identification as a file identification associated with the second partner.

11. The method of claim 10, further comprising a step before the accessing step of:
reading in the file the file identification associated with the first partner using a record defining the location in the file of the file identification associated with the first partner.

12. The method of claim 11, wherein the reading step comprises:
reading in the file the file identification associated with the first partner using multiple records defining multiple locations in the file wherein each location constitutes a portion of the file identification.

13. The method of claim 11, wherein the record defining the location in the file of the file identification associated with the first partner comprises a path defining the location in the file of the file identification associated with the first partner.

14. The method of claim 11, wherein the generating step comprises:
generating a global file identification including a unique value.

15. A method for mapping identifications, comprising:
receiving a file from a first partner, wherein the file includes a file identification associated with the first partner;
accessing a database for linking file identifications associated with the first partner and file identifications associated with a second partner;
determining if the database includes a link between the file identification associated with the first partner and a file identification associated with the second partner;
wherein if the database includes a link between the file identification associated with the first partner and a file identification associated with the second partner,
determining, based on the database, a file identification associated with the second partner that corresponds to the file identification associated with the first partner;
integrating the file identification associated with the second partner with the file; and
sending the file to the second partner.

16. The method of claim 15, wherein if the database does not include a link between the file identification associated with the first partner and a file identification associated with the second partner,
generating a global file identification for the file;
integrating the global file identification with the file;
sending the file to the second partner;
receiving from the second partner a file identification associated with the second partner, wherein the file identification corresponds to the file;
accessing a database for linking file identifications associated with the first partner and file identifications associated with a second partner; and
entering into the database a link between the file identification associated with the first partner and the file identification associated with the second partner.

17. A method on a first partner for mapping identifications, comprising:
accessing a database for linking file identifications associated with the first partner and file identifications associated with a second partner;
determining, based on the database, a file identification associated with the second partner that corresponds to a file identification associated with the first partner;
integrating the file identification associated with the second partner with a file comprising the file identification associated with the first partner; and
sending the file to the second partner.

18. A method on a first partner for mapping identifications, comprising:
generating a global file identification for a file from the first partner, wherein the file includes a file identification associated with the first partner;
integrating the global file identification with the file;
sending the file to the second partner;
receiving from the second partner a file identification associated with the second partner, wherein the file identification corresponds to the file;
accessing a database for linking file identifications associated with the first partner and file identifications associated with a second partner; and
entering into the database a link between the file identification associated with the first partner and the file identification associated with the second partner.

19. A system for mapping identifications, comprising:
a first file from a first partner, wherein the first file includes a file identification associated with the first partner;
a database for linking file identifications associated with the first partner and file identifications associated with a second partner;
a second file comprising data from the first file, wherein the second file includes a file identification associated with the second partner.

20. The system of claim 19, further comprising:
a record defining the location in the first file of the file identification associated with the first partner.

21. The system of claim 20, wherein the record defining the location in the first file of the file identification associated with the first partner comprises a path defining the location in the first file of the file identification associated with the first partner.

22. The system of claim 19, further comprising:
multiple records defining multiple locations in the file wherein each location constitutes a portion of the file identification.

23. A system for mapping identifications, comprising:
a first file from a first partner, wherein the first file includes a file identification associated with the first partner;
an identification generator for generating a global file identification for the first file;
a second file comprising data from the first file, wherein the second file includes the global file identification;
a file identification associated with the second partner, wherein the file identification corresponds to the first file;
a database for linking file identifications associated with the first partner and file identifications associated with a second partner; and
a link in the database between the file identification associated with the first partner and the file identification associated with the second partner.

24. The system of claim 23, further comprising:
a record defining the location in the file of the file identification associated with the first partner.

25. The system of claim 23, further comprising:
multiple records defining multiple locations in the file wherein each location constitutes a portion of the file identification.

26. The system of claim 23, wherein the record defining the location in the file of the file identification associated with the first partner comprises a path defining the location in the file of the file identification associated with the first partner.

27. The system of claim 23, wherein the global file identification includes a unique value.

28. A system for mapping identifications, comprising:
a first file from a first partner, wherein the first file includes a file identification associated with the first partner;
an identification generator for generating a global file identification for the first file;
a second file comprising data from the first file, wherein the second file includes the global file identification;
a database for linking file identifications associated with the first partner and global file identifications; and
a link in the database between the file identification associated with the first partner and the global file identification.

29. The system of claim 28, further comprising:
a record defining the location in the file of the file identification associated with the first partner.

30. The system of claim 28, further comprising:
multiple records defining multiple locations in the file wherein each location constitutes a portion of the file identification.

31. The system of claim 28, wherein the record defining the location in the file of the file identification associated with the first partner comprises a path defining the location in the file of the file identification associated with the first partner.

32. The system of claim 28, wherein the global file identification includes a unique value.

33. A system on a first partner for mapping identifications, comprising:
a database for linking file identifications associated with the first partner and file identifications associated with a second partner;
a file identification associated with the second partner that corresponds to a file identification associated with the first partner; and
a file comprising the file identification associated with the second partner, wherein the file identification associated with the second partner corresponds to the file identification associated with the first partner according to the database.

34. A system on a first partner for mapping identifications, comprising:
an identification generator for generating a global file identification for a first file from the first partner, wherein the first file includes a file identification associated with the first partner;
a second file comprising data from the first file, wherein the second file includes the global file identification; and
a file identification associated with the second partner, wherein the file identification corresponds to the first file.

35. A computer readable medium including computer instructions for mapping identifications, the computer instructions including instructions for:
receiving a file from a first partner, wherein the file includes a file identification associated with the first partner;
accessing a database for linking file identifications associated with the first partner and file identifications associated with a second partner;
determining, based on the database, a file identification associated with the second partner that corresponds to the file identification associated with the first partner;
integrating the file identification associated with the second partner with the file; and
sending the file to the second partner.

36. The computer readable medium of claim 35, further comprising a step before the accessing step of:
reading in the file the file identification associated with the first partner using a record defining the location in the file of the file identification associated with the first partner.

37. The computer readable medium of claim 36, wherein the record defining the location in the file of the file identification associated with the first partner comprises a path defining the location in the file of the file identification associated with the first partner.

38. The computer readable medium of claim 36, wherein the instructions for reading comprise:
reading in the file the file identification associated with the first partner using multiple records defining multiple locations in the file wherein each location constitutes a portion of the file identification.

39. A computer readable medium including computer instructions for mapping identifications, the computer instructions including instructions for:
receiving a file from a first partner, wherein the file includes a file identification associated with the first partner;
generating a global file identification for the file;
integrating the global file identification with the file;
sending the file to the second partner;
receiving from the second partner a file identification associated with the second partner, wherein the file identification corresponds to the file;
accessing a database for linking file identifications associated with the first partner and file identifications associated with a second partner; and
entering into the database a link between the file identification associated with the first partner and the file identification associated with the second partner.

40. The computer readable medium of claim 39, further comprising instructions for:
reading in the file the file identification associated with the first partner using a record defining the location in the file of the file identification associated with the first partner.

41. The computer readable medium of claim 40, wherein the instructions for reading comprise:
reading in the file the file identification associated with the first partner using multiple records defining multiple locations in the file wherein each location constitutes a portion of the file identification.

42. The computer readable medium of claim 40, wherein the record defining the location in the file of the file identification associated with the first partner comprises a path defining the location in the file of the file identification associated with the first partner.

43. The computer readable medium of claim 40, wherein the instructions for generating comprise:
generating a global file identification including a unique value.

44. A computer readable medium including computer instructions for mapping identifications, the computer instructions including instructions for:
receiving a file from a first partner, wherein the file includes a file identification associated with the first partner;
generating a global file identification for the file;
integrating the global file identification with the file;
sending the file to the second partner;
entering into the database a link between the file identification associated with the first partner and the global file identification; and
using the global file identification as a file identification associated with the second partner.

45. The computer readable medium of claim 44, further comprising instructions for:
reading in the file the file identification associated with the first partner using a record defining the location in the file of the file identification associated with the first partner.

46. The computer readable medium of claim 45, wherein the instructions for reading comprise:
reading in the file the file identification associated with the first partner using multiple records defining multiple locations in the file wherein each location constitutes a portion of the file identification.

47. The computer readable medium of claim 45, wherein the record defining the location in the file of the file identification associated with the first partner comprises a path defining the location in the file of the file identification associated with the first partner.

48. The computer readable medium of claim 45, wherein the instructions for generating comprise:
generating a global file identification including a unique value.

49. A computer readable medium including computer instructions for mapping identifications, the computer instructions including instructions for:
receiving a file from a first partner, wherein the file includes a file identification associated with the first partner;
accessing a database for linking file identifications associated with the first partner and file identifications associated with a second partner;
determining if the database includes a link between the file identification associated with the first partner and a file identification associated with the second partner;
wherein if the database includes a link between the file identification associated with the first partner and a file identification associated with the second partner,
determining, based on the database, a file identification associated with the second partner that corresponds to the file identification associated with the first partner;
integrating the file identification associated with the second partner with the file; and
sending the file to the second partner.

50. The computer readable medium of claim 49, wherein if the database does not include a link between the file identification associated with the first partner and a file identification associated with the second partner,
generating a global file identification for the file;
integrating the global file identification with the file;
sending the file to the second partner;
receiving from the second partner a file identification associated with the second partner, wherein the file identification corresponds to the file;
accessing a database for linking file identifications associated with the first partner and file identifications associated with a second partner; and
entering into the database a link between the file identification associated with the first partner and the file identification associated with the second partner.

51. A computer readable medium on a first partner including computer instructions for mapping identifications, the computer instructions including instructions for:
accessing a database for linking file identifications associated with the first partner and file identifications associated with a second partner;
determining, based on the database, a file identification associated with the second partner that corresponds to a file identification associated with the first partner;
integrating the file identification associated with the second partner with a file comprising the file identification associated with the first partner; and
sending the file to the second partner.

52. A computer readable medium on a first partner including computer instructions for mapping identifications, the computer instructions including instructions for:
generating a global file identification for a file from the first partner, wherein the file includes a file identification associated with the first partner;
integrating the global file identification with the file;
sending the file to the second partner;
receiving from the second partner a file identification associated with the second partner, wherein the file identification corresponds to the file;
accessing a database for linking file identifications associated with the first partner and file identifications associated with a second partner; and
entering into the database a link between the file identification associated with the first partner and the file identification associated with the second partner.
